(19) United States
(12) Patent Application Publication
(10) Pub. No.: US 2006/0238588 A1
(43) Pub. Date: Oct. 26, 2006

(54) Ink set, ink jet printer cartridge and ink jet printing apparatus using the same

(76) Inventors: Jong-in Lee, Suwon-si (KR); Seung-min Ryu, Yongin-si (KR)

Correspondence Address: STANZIONE & KIM, LLP, 919 18TH STREET, N.W., SUITE 440, WASHINGTON, DC, 20006, US

(21) Appl. No.: 11/354,990

(22) Filed: Feb. 16, 2006

(30) Foreign Application Priority Data
Apr. 20, 2005 (KR) 10-2005-32763

(51) Int. Cl. G01D 11/00; C09D 11/02

(52) U.S. Cl. 347/100; 106/31.27; 106/31.6; 106/31.59; 106/31.89; 106/31.58; 106/31.86; 106/31.87; 106/31.47; 106/31.49; 106/31.77; 106/31.78; 106/31.43; 106/31.75

(57) ABSTRACT

An ink set includes at least two color inks having different colors, in which each color ink includes colorants, surfactants, organic solvents, and water, and a difference between dynamic surface tensions of the at least two color inks is 20 dyne/cm or less at 10 ms and 1000 ms. An ink jet printer cartridge can include the ink set, and an ink jet printing apparatus can include the ink jet printer cartridge. When a full color image is printed on a recording medium using an ink set having inks with similar dynamic surface tensions, a drying time is shortened, and a clear image without color boundary bleeding can be realized with reproducibility.

CROSS-REFERENCE TO RELATED APPLICATIONS

This application claims the benefit under 35 U.S.C. §119 of Korean Patent Application No.10-2005-32763, filed on Apr. 20, 2005, in the Korean Intellectual Property Office, the disclosure of which is incorporated herein in its entirety.

### BACKGROUND OF THE INVENTION

1. Field of the Invention

The present general inventive concept relates to an ink set, an ink jet printer cartridge and an ink jet printing apparatus using the same. More specifically, the present general inventive concept relates to an ink set including inks having similar dynamic surface tensions and rapid drying times, which can realize a clear image without color boundary bleeding when a full color image is printed on a recording medium with the ink set, and an ink jet printer cartridge and an ink jet printing apparatus using the same.

2. Description of the Related Art

Printing methods using a printer can generally be classified into non-impact printing methods and impact printing methods. Ink jet printing is a type of non-impact printing method and has the advantages of low noise generation and easier color realization as compared to laser beam printing.

Also, ink jet printing can be classified into two methods, a continuous stream method and a drop-on-demand (DOD) method.

In the continuous stream method, ink is jetted continuously from orifices or nozzles by pressure. The jetted ink is dispersed at a given distance from the orifices by forming droplets. The droplets are charged according to digital signals while being dispersed, and orbits of the droplets are controlled by being passed through a magnetic field, so that the droplets are recycled or set out for a gutter, that is at a given position on a recording medium.

In the drop-on-demand method, the droplets are jetted directly according to digital signals from orifices to a position on a recording medium. The ink that is not jetted to the recording medium is not formed into droplets or discharged from the orifices. The drop-on-demand method is much simpler than the continuous stream method, since the drop-on-demand method does not require ink recovery, charging, or deflection.

The drop-on-demand method can be classified into two methods, a thermal ink jet (referring to a bubble jet) method and a piezoelectric ink jet method.

In the thermal ink jet method, ink is jetted by pressure created from expansion of bubbles caused by heating the ink. The thermal ink jet method produces droplets having high velocity through nozzles disposed closely together. The thermal ink jet method can be performed by a printer that can maintain rapid printing ability and is simpler and less expensive than the continuous stream method.

Due to recent technology, a dot size in the ink jet printer has decreased and a speed of the ink jet printer has increased, in order to provide high quality printing with high resolution. To obtain the smaller dot size, a printer head must have a smaller nozzle opening. However, the smaller nozzle opening is easily clogged and performance of ink jet droplets depends on precipitants and the like that affect their size.

A composition of ink is a factor that affects clogging of the nozzles. To avoid the clogging, wetting agents have typically been added to ink for an ink jet printer.

The ink for an ink jet printer should have a sufficient optical density to maintain discharging stabilities without clogging the nozzles. Additionally, when a black ink is used in combination with other color inks, such as at least one color ink selected from the group consisting of magenta ink, cyan ink, yellow ink, red ink, green ink, and blue ink to print color images, a reduction of image quality due to smudging of ink and nonhomogeneous mixing of ink in the boundary between black image parts and color image parts (hereinafter, it is referred to as color boundary bleeding) should not occur.

To avoid or reduce the color boundary bleeding, a method of improving absorption abilities of ink into a recording medium by adding so called surfactants (for example, Japanese patent application laid open No. 55-65269) and a method of reducing a drying time of ink by using volatile solvents as solvents of ink (Japanese patent application laid open No. 55-66976) have been proposed.

However, when specific additives are used to obtain the improvements, discharging stabilities are decreased, and an optical density of an image and an image quality are decreased due to excessive absorption into a recording medium.

### SUMMARY OF THE INVENTION

The present general inventive concept provides an ink set that has rapid drying time and can realize a clear image without color boundary bleeding when a full color image is printed on a recording medium.

The present general inventive concept also provides an ink jet printer cartridge using the ink set.

The present general inventive concept also provides an ink jet printing apparatus including the ink jet printer cartridge.

Additional aspects and utilities of the present general inventive concept will be set forth in part in the description which follows and, in part, will be obvious from the description, or may be learned by practice of the general inventive concept.

The foregoing and/or other aspects of the present general inventive concept are achieved by providing an ink set including at least two color inks having different colors, each color ink including colorants, surfactants, organic solvents, and water, wherein a difference between dynamic surface tensions of the at least two inks is 20 dyne/cm or less at 10 ms and 1000 ms.

The foregoing and/or other aspects of the present general inventive concept are also achieved by providing an ink jet printer cartridge including an ink set including at least two color inks having different colors, each color ink including colorants, surfactants, organic solvents, and water, wherein a difference between dynamic surface tensions of the at least two inks is 20 dyne/cm or less at 10 ms and 1000 ms.

The foregoing and/or other aspects of the present general inventive concept are also achieved by providing an ink jet printing apparatus including an ink jet printer cartridge containing an ink set including at least two color inks having different colors, each color ink comprising colorants, surfactants, organic solvents, and water, wherein a difference between dynamic surface tensions of the at least two inks is 20 dyne/cm or less at 10 ms and 1000 ms.

The foregoing and/or other aspects of the present general inventive concept are also achieved by providing an ink set usable with an ink jet printer, including a plurality of different color inks, each color ink having a dynamic surface tension within 20 dyne/cm of the dynamic surface tensions of the other color inks at 10 ms and at 1000 ms during a formation of droplets of the different color inks.

The foregoing and/or other aspects of the present general inventive concept are also achieved by providing an ink jet cartridge set, including a plurality of ink jet cartridges respectively containing a plurality of different color inks, each color ink having a dynamic surface tension within 20 dyne/cm of the dynamic surface tensions of the other color inks at 10 ms and at 1000 ms during a formation of droplets of the different color inks.

The foregoing and/or other aspects of the present general inventive concept are also achieved by providing an ink jet printing apparatus, including one or more ink cartridges, an ink set provided in the one or more ink cartridges, the ink set comprising a plurality of different color inks, each color ink having a dynamic surface tension within 20 dyne/cm of the dynamic surface tensions of the other color inks at 10 ms and at 1000 ms during a formation of droplets of the different color inks, and an ink jet print head having a plurality of nozzles to eject the different color inks of the ink set onto a printing medium to form an image on the printing medium.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a view illustrating an ink jet printing apparatus according to an embodiment of the present general inventive concept.

FIG. 2 is a cross sectional view illustrating an ink cartridge including an ink set according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

A surface tension of ink containing a surfactant depends on the concentration of the surfactant that is present at a surface of the ink. If ink containing the same type surfactant is used, the more surfactant that is present at the surface of the ink, the lower the surface tension of the ink is.

In foaming, emulsification, and the like of the ink, when a new surface is formed by rapid expansion of a surface or interface of the ink, the surfactant in the ink moves to the newly formed surface and the surface tension is reduced from an initial surface tension of pure solution without the surfactant (about 72.4 dyne/cm, distilled water, at 25° C.) to an equilibrium surface tension of the ink containing the surfactant.

In this case, if a rate of reaching the equilibrium is fast, the surface tension of the ink reaches the equilibrium value quickly. However, if the rate of reaching the equilibrium is slow, the surface tension of the ink reaches the equilibrium value slowly. The surface tension of the ink in a transition state that is changing from the initial surface tension of the pure solution to the equilibrium surface tension is referred as to a dynamic surface tension, and the dynamic surface tension depends on the rate and time of forming the new surface of the ink.

The dynamic surface tension is closely related to forming a new interface (i.e., forming an ink droplet) by heating the ink in a thermal ink jet method and a change of orientation of the surfactant as a function of time. A change of the dynamic surface tension as a function of time affects a degree of absorption of the ink relative to paper, and hence drying time of the ink and color boundary bleeding can be affected.

According to the present general inventive concept, the dynamic surface tension is determined to be in a range to realize an optimum printing image by preparation of inks using various surfactants, determination of the dynamic surface tension of the inks, and evaluation of the inks in terms of color boundary bleeding, penetration, optical density, and the like.

If a difference between the dynamic surface tensions of at least two inks is 20 dyne/cm or less at 10 ms and 1000 ms, the drying time is shortened and a clear image without color boundary bleeding can be realized, and such inks can be used as an ink set in a multicolor printer.

The difference between the dynamic surface tensions of at least two inks can be from 0.01 to 20 dyne/cm or less at 10 ms and 1000 ms. Here, 10 ms and 1000 ms refer to time that is required to form ink droplets in a determination of the dynamic surface tension using a bubble pressure method. Accordingly, when the ink droplets of the at least two inks are being formed, the difference of the dynamic surface tensions of the at least two inks is 20 dyne/cm or less at 10 ms into the formation process of the ink droplets and at 1000 ms into the formation process of the ink droplets. The dynamic surface tension can be determined with BP2-MK2 manufactured by Kruss at an ambient temperature (25° C.) and a pressure of 1 atm in the range of 10 ms through 5000 ms.

The dynamic surface tension of the ink can be substantially 30 to 70 dyne/cm at 10 ms, and substantially 22 to 60 dyne/cm at 1000 ms.

According to an embodiment of the present general inventive concept, if the ink includes a first color ink and a second color ink, which have different colors from each other, the dynamic surface tension of the second color ink can be within 20 dyne/cm or less at 10 ms and 1000 ms of the dynamic surface tension of the first color ink.

If the ink includes the first color ink, the second color ink, and a third color ink, which have different colors from each other, the dynamic surface tension of the second color ink is within 20 dyne/cm or less at 10 ms and 1000 ms of the dynamic surface tension of the first color ink, and the dynamic surface tension of the third color ink is within 20 dyne/cm or less at 10 ms and 1000 ms of the dynamic surface tension of the first color ink and the dynamic surface tension of the second color ink.

Additionally, if the ink includes the first color ink, the second color ink, the third color ink and a fourth color ink, which have different colors from each other, the dynamic surface tension of the second color ink is within 20 dyne/cm or less at 10 ms and 1000 ms of the dynamic surface tension of the first color ink, the dynamic surface tension of the third color ink is within 20 dyne/cm or less at 10 ms and 1000 ms of the dynamic surface tension of the first color ink and the dynamic surface tension of the second color ink, and the dynamic surface tension of the fourth color ink is within 20 dyne/cm or less at 10 ms and 1000 ms relative to the dynamic surface tensions of the first, second, and third color inks.

According to an embodiment of the present general inventive concept, the first color is black, and the second color, the third color, and the fourth color are colors selected from a group consisting of magenta, cyan, yellow, red, green and blue.

Each of the different colors of ink contains colorants. The colorants can be self-dispersing dyes, self-dispersing pigments, or dyes or pigments that are used in combination with dispersants.

The colorants can include black pigments to make the black color ink, and at least one of dyes or pigments containing at least one color selected from the group consisting of magenta, cyan, yellow, red, green and blue to make at least one of magenta, cyan, yellow, red, green, and blue ink.

If the ink set includes the black ink containing the black colorants and color ink containing at least one color colorants selected from the group consisting of magenta, cyan, yellow, red, green and blue, a drop volume of the black ink can be four times or less, for example, 1 through 2.5 times or less, greater than a drop volume of the color ink. If the drop volume of black ink is more than four times greater than the drop volume of other color inks, a size of a dot formed by one droplet of the black ink becomes significantly larger than a size of a dot formed by other colors, and hence it is difficult to balance the black ink with color ink when filling a given area. To balance the black ink with the color ink, the color ink having a small drop volume can be discharged many times. However, since numerous discharges cause a reduction of printing speed, the drop volume of the black ink should be no more than four times the drop volume of the ink of the other colors.

Furthermore, if the ink set includes the black ink containing the black colorants and the color ink containing at least one color colorants selected from the group consisting of magenta, cyan, yellow, red, green and blue, the drop volume of the black ink can be 18 pl (picoliters) or less, for example, 12 pl or less, or substantially 0.1 to 12 pl. If the drop volume of the black ink is greater than 18 pl, a nozzle size of a head chip discharging the drop volume must become larger. Since a large nozzle size is a factor that restricts nozzle integration for rapid printing or high accuracy, and hence cannot be applied to an array head, the drop volume of the black ink should be no greater than 18 pl.

According to embodiments of the present general inventive concept, ionic surfactants or non-ionic surfactants can be used as the surfactants in the ink. An amount of the surfactants in the ink is in a range of substantially 0.01 to 2 parts by weight based on 1 part by weight of the colorants. If the amount of the surfactants is less than 0.01 parts by weight, the effect of reducing the surface tension of the ink may be insignificant. If the amount of the surfactants is greater than 2 parts by weight, it may be difficult to form suitable droplets because the surface tension is too low, and discharging becomes inaccurate due to excess wetting of the surface of nozzle.

The ionic surfactants can include salts of alkylcarboxylic acid, salts of alcohol sulfonic acid ester, salts of alkylsulfonic acid, salts of alkylbenzenesulfonic acid, fatty acid amine salts, quaternary ammonium salts, sulfonium salts, or phosphonium salts. The non-ionic surfactants can include polyoxyethylene alkyl ether, polyoxyethylene alkyl phenyl ether, polyoxyethylene secondary alcohol ether, polyoxyethylene-oxypropylene block copolymer, polyglycerin fatty acid ester, sorbitan monoester alkoxylate, acetylenic polyalkylene oxide, acethylenic diol, and the like, but the present general inventive concept is not limited thereto.

Organic solvents used in the ink can include cosolvents, amide based compounds, or mixtures thereof, and a total amount of the organic solvents is in a range of substantially 0.5 to 20 parts by weight based on 1 part by weight of the colorants. If the amount of the organic solvents is less than 0.5 parts by weight, it may be difficult to realize a wetting effect and storage stability. If the amount of the organic solvents is greater than 20 parts by weight, the viscosity may be too high, and the particle size rapidly increases.

The cosolvents can include alcohol compounds including methyl alcohol, ethyl alcohol, n-propyl alcohol, isopropyl alcohol, n-butyl alcohol, sec-butyl alcohol, t-butyl alcohol or isobutyl alcohol; polyhydric alcohol compounds including 1,6-hexanediol, 1,2-hexanediol, ethylene glycol, diethylene glycol, triethylene glycol, propylene glycol, buthylene glycol, 1,4-butanediol, 1,2,4-butanetriol, 1,5-pentanediol, 1,2,6-hexanetriol, trimethanol propane, hexylene glycol, glycerol, poly (ethylene glycol), and the like; ketone compounds including acetone, methyl ethyl ketone, diacetone alcohol and the like; esters including ethylacetate, ethyl lactate; lower alkyl ether compounds including ethylene glycol monomethyl ether, ethylene glycol monoethyl ether, diethylene glycol methyl ether, diethylene glycol ethyl ether, diethylene glycol monobutyl ether, diethylene glycol diethylene ether, triethylene glycol monomethyl ether, triethylene glycol monoethyl ether and the like; sulfur-containing compounds selected from the group consisting of dimethyl sulfoxide, tetramethylenesulfone, thioglycol; or mixtures thereof, but the present general inventive concept is not limited thereto.

The amide based compounds can include at least one selected from the group consisting of 2-pyrrolidone, 2-piperidone, N-methyl-pyrrolidone, caprolactame, tetrahydro-2-pyrimidone, 3-methyl-tetrahydro-2-pyrimidone, 2-imidazolidinone, dimetylimidazolidinone, diethylimidazolidinone, butyl urea, 1,3-dimethyl urea, ethyl urea, propyl urea, isopropyl urea, 1,3-diethyl urea.

If a mixture of the cosolvents and the amide based compounds is used together as the organic solvents, the amount of the amide based compounds is in a range of substantially 0.1 to 50 parts by weight based on 100 parts by weight of the organic solvents.

In the ink composition according to embodiments of the present general inventive concept, an amount of water may be in a range of substantially 1 to 30 parts by weight based on 1 part by weight of the colorants. If the amount of water is less than 1 part by weight, the viscosity of the aqueous ink solution may increase because the colorant density in the aqueous ink solution is too high. If the amount of water is greater than 30 parts by weight, it may be difficult to express a desired color because the colorant content in the aqueous ink solution is too low.

Additionally, the ink can further include viscosity controlling agents and the like.

Furthermore, the ink can further include acids or bases. The acids or bases have functions to increase solubilities of wetting agents to solvents and stabilize pigments.

Hereinafter, a process of preparing the ink and the ink set having the composition as described above will be described.

First color colorants, surfactants, organic solvents and the like are added to water to form a mixture. The mixture is mixed by fully stirring the mixture with a stirrer to homogenize the mixture.

The homogenized mixture is then passed through a filter and filtered to obtain ink.

The ink set of the present general inventive concept can be obtained by mixing the first color ink containing the first color colorants, as described above, then mixing the second color ink containing second color colorants in a similar manner to the mixing of the first color ink, mixing the third color ink containing third color colorants in a similar manner, etc.

The different color inks of the ink set each has a surface tension of substantially 15 to 70 dyne/cm and has a viscosity of substantially 1.0 to 20 Cp at 20° C. Each of the different color inks of the ink set dry within 3 seconds or less, for example 0.1 to 1 seconds, on a paper printing medium. Accordingly, the inks of the ink set have a fast drying speed.

The different color inks of the ink set can also be used in various applications such as toner compositions, various paints, coating solutions, and the like. For example, according to an embodiment of the present general inventive concept, the ink set can be used in an ink jet printer cartridge usable with an ink jet printer provided with an array head.

The ink jet printer with the array head is capable of rapid printing by using a number of chips disposed in a widthwise direction of a printing medium, as compared to a shuttle type ink jet printer in which printing is performed by transferring one chip in the widthwise direction of a printing medium to print on the printing medium.

The ink jet printer provided with the array head can use 10,000 or more nozzles, for example, between 10,000 to 1,000,000 nozzles. In the inkjet printer with the array head, when the ink set includes at least two multicolor inks, such as black ink and color ink, the drop volume of black ink is 18 pl or less, and a difference between the dynamic surface tensions of the two inks is 20 dyne/cm or less at 10 ms and 1000 ms respectively.

The ink set is suitable for the ink jet printer provided with the array head using 10,000 or more nozzles. Because the ink jet printer having a number of nozzles discharges small drop volumes to form small dots, the drop volume of the ink is 18 pl or less to allow a rapid printing speed. Furthermore, the inks of the ink set have dynamic surface tensions within 20 dyne/cm of each other at 10 ms and 1000 ms in order to realize an image without color boundary bleeding, even during rapid printing.

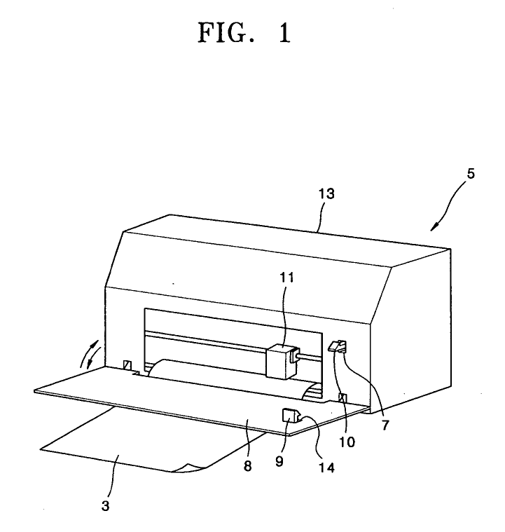

FIG. 1 is a view illustrating an ink jet printing apparatus according to an embodiment of the present general inventive concept.

Referring to FIG. 1, the ink jet printing apparatus includes an ink cartridge 11 having the ink set according to the present general inventive concept. A printer cover 8 is connected to a main body 13. An interlocking region of a movable latch 10 projects through a hole 7, and the interlocking region of the movable latch 10 interlocks with a fitting latch 9. The fitting latch 9 is connected to an internal surface of the printer cover 8, and interlocks with the movable latch when the printer cover 8 is closed. The cover 8 has recess 14 provided at the fitting latch and corresponding to the interlocking region of the movable latch 10 to allow the movable latch 10 and the fitting latch 9 to interlock. The ink cartridge 11 is mounted to allow the different color inks of the ink set to be dispersed to paper 3 that passes a lower part of the ink cartridge 11.

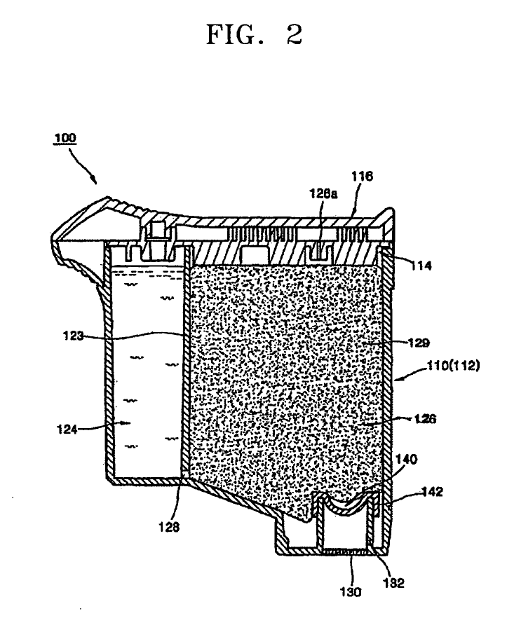

FIG. 2 is a cross-sectional view illustrating an ink cartridge 100 comprising the ink set according to an embodiment of the present general inventive concept. The ink cartridge 100 is provided with a cartridge main body 110 forming an ink reservoir 112, an internal cover 114 covering a top region of the ink reservoir 112, and an external cover 116 that can be distal in distance from the internal cover 114 and seals the ink reservoir 112 and the internal cover 114. The ink cartridge 100 can have a separate ink reservoir 112 corresponding to each of the different color inks of the ink set. Alternatively, a separate ink cartridge 100 can be provided for each of the different color inks of the ink set.

The ink reservoir 112 is comparted into a first chamber 124 and a second chamber 126 by a vertical barrier wall 123. An ink passage 128 between the first chamber 124 and the second chamber 126 can be formed at a bottom of the vertical barrier wall 123. The first chamber 124 is filled with ink, and the second chamber 126 is also filled with ink and can include a sponge 129 filled with ink. A bent hole 126a corresponding to the second chamber 126 is formed in the internal cover 114.

A filter 140 is formed at a bottom of the second chamber 126 to filter impurities and fine bubbles in the ink, thereby preventing ejection holes from clogging. A hook 142 can be formed at edges of the filter 140 to be disposed (coupled) at a top region of a standpipe 132. The ink in the ink reservoir 112 is ejected through ejection holes of a printer head 130 in the form of small droplets to a recording medium.

Embodiments of the present general inventive concept will be described in greater detail with reference to the following examples. The following examples are for illustrative purposes and are not intended to limit the scope of the general inventive concept.

### EXAMPLE

<Colorants>

Black 1: Raven 5250, manufactured by Columbia Co.,

Black 2: Regal 330, manufactured by Cabot Co.,

Cyan 1: Direct Turquoise Blue, manufactured by Clariant,

Cyan 2: Direct Blue 199, manufactured by Hodogaya,

Magenta 1: Basacid Rot 495, manufactured by BASF,

Magenta 2: Acid Red 52, manufactured by Hodogaya,

Yellow 1: Yellow GGN, manufactured by Spectra,

Yellow 2: Basacid Yellow 099, manufactured by BASF.

<Organic Solvents>

EG: Ethylene Glycol

DEG: Diethylene Glycol

Gly: Glycerine

1,2,6-hex: 1,2,6-hexanetriol

DEGMBE: Diethyleneglycol Monobutyl Ether

<Amide Compounds>

2-P: 2-pyrrolidine

NMP: N-methyl-2-pyrrolidone

Cyclo-P: Cyclohexyl pyrrolidone

C-lactam: Caprolactam

V-lactam: Valerolactam

<Surfactants>

surfactant 1: Disperbyk-181, manufactured by BYK

surfactant 2: Surfynol 465, manufactured by Air Product

surfactant 3: Tergitol, manufactured by ICI

surfactant 4: Pluronics, manufactured by BASF

surfactant 5: Sodium dicyclohexyl sulfosuccinate, manufactured by CYTEC

Ink samples were prepared using the colorants and organic solvents described above, according to the following method.

For the ink in each of the ink samples, organic solvents that are suitable for ink characteristics were added into a 250 ml beaker according to the composition described in Table 1 below, and then water was added to the beaker to a final weight of 100 g. The mixture was then stirred at 700 rpm for 30 minutes or longer for homogenisation, and filtered through a 0.45 um filter paper to obtain a final ink composition.

TABLE 1

| | Colorant | |
|---|---|---|
| Sample | (parts by weight) | Organic solvent (parts by weight) |
| Ink 1 | Black 1 (4) | EG (8), DEG (6), surfactant 1 (0.3) |
| Ink 2 | Cyan 1 (4) | Gly (10), DEGMBE (8), NMP (5), |
| | | surfactant 3 (0.5) |
| Ink 3 | Magenta 1 (4) | 1,2,6-Hex (10), Cyclo-P (8), |
| | | surfactant 2 (0.7) |
| Ink 4 | Yellow 1 (5) | Gly (10), DEG (6), |
| | | V-lactam (4), surfactant 4 (1.0) |
| Ink 5 | Black 2 (4) | EG (6), 2-P (5), surfactant 5 (0.5), |
| | | surfactant 3 (0.05) |
| Ink 6 | Cyan 2 (4) | Gly (10), DEGMBE (2), NMP (7), |
| | | Surfactant 2 (0.8) |
| Ink 7 | Magenta 2 (4) | 1,2,6-Hex (10), DEG (6), |
| | | Cyclo-P (6), surfactant 4 (1.0) |
| Ink 8 | Yellow 2 (5) | Gly (12), C-lactam (4), |
| | | Surfactant 1 (0.6) |
| Ink 9 | Black 1 (4) | EG (8), DEG (6), surfactant 1 (0.6) |
| Ink 10 | Black 1 (4) | EG (8), DEG (6), surfactant 1 (0.9) |
| Ink 11 | Black 1 (4) | EG (8), DEG (6), surfactant 1 (1.2) |
| Ink 12 | Cyan 1 (4) | Gly (10), DEGMBE (8), NMP (5), |
| | | surfactant 3 (0.8) |
| Ink 13 | Magenta 1 (4) | 1,2,6-Hex (10), Cyclo-P (8), |
| | | surfactant 2 (1.2) |
| Ink 14 | Yellow 1 (5) | Gly (10), DEG (6), |
| | | V-lactam (4), surfactant 4 (1.6) |

The dynamic surface tension of each of the ink combinations (ink 1˜ink 4 and ink 5˜ink 8) of the ink compositions in Table 1 when used in an ink jet printer was measured. The results are illustrated in Table 2. In Examples 1 through 6, the differences in the dynamic surface tensions between ink 1, ink 2, ink 3, and ink 4 were measured. In Comparative Examples 1 through 3, the differences in the dynamic surface tensions between ink 5, ink 6, ink 7, and ink 8 were measured. In Comparative Examples 1 through 3, the differences in the dynamic surface tensions between other color inks with respect to black ink having a high dynamic surface tension were measured. Comparative Examples 1 through 3 are cases in which the differences in dynamic surface tensions between the color inks and the black ink are greater than 20 dyne/cm.

TABLE 2
Dynamic surface tension

| | | | | Comparative | | | |
|---|---|---|---|---|---|---|---|
| Example | Ink | 10 ms | 1000 ms | Example | Ink | 10 ms | 1000 ms |
| Example 1 | Ink 1 | 53.1 | 48.2 | Comparative | Ink 5 | 64.2 | 56.6 |
| | Ink 2 | 40.4 | 34.7 | Example 1 | Ink 6 | 32.0 | 30.2 |
| | Difference | 12.7 | 13.5 | | Difference | 32.2 | 26.4 |
| Example 2 | Ink 1 | 53.1 | 48.2 | Comparative | Ink 5 | 59.2 | 51.6 |
| | Ink 3 | 37.6 | 33.7 | Example 2 | Ink 7 | 30.9 | 25.0 |
| | Difference | 15.5 | 14.5 | | Difference | 28.3 | 26.6 |
| Example 3 | Ink 1 | 53.1 | 48.2 | Comparative | Ink 5 | 59.2 | 51.6 |
| | Ink 4 | 34.6 | 29.6 | Example 3 | Ink 8 | 33.9 | 30.8 |
| | Difference | 18.5 | 18.6 | | Difference | 25.3 | 20.8 |
| Example 4 | Ink 2 | 40.4 | 34.7 | | | | |
| | Ink 3 | 37.6 | 33.7 | | | | |
| | Difference | 2.8 | 1.0 | | | | |
| Example 5 | Ink 3 | 37.6 | 33.7 | | | | |
| | Ink 4 | 34.6 | 29.6 | | | | |
| | Difference | 3.0 | 4.1 | | | | |
| Example 6 | Ink 4 | 34.6 | 29.6 | | | | |
| | Ink 2 | 40.4 | 34.7 | | | | |
| | Difference | 5.8 | 5.1 | | | | |

TABLE 3
Drop volume (Bk/C: Black ink/Color ink ratio)

| | | | | | Drop |
|---|---|---|---|---|---|
| | | Drop volume | Comparative | | volume |
| Example | | (pl) | Example | | (pl) |
| Example 7 | Ink 1 | 17.2 | Comparative | Ink 1 | 17.2 |
| | Ink 2 | 5.6 | Example4 | Ink 12 | 4.2 |
| | Bk/C | 3.1 | | Bk/C | 4.1 |
| Example 8 | Ink 1 | 17.2 | Comparative | Ink 1 | 17.2 |
| | Ink 3 | 4.8 | Example5 | Ink 13 | 3.4 |
| | Bk/C | 3.6 | | Bk/C | 5.1 |
| Example 9 | Ink 1 | 17.2 | Comparative | Ink 1 | 17.2 |
| | Ink 4 | 4.4 | Example6 | Ink 14 | 2.0 |
| | Bk/C | 3.9 | | Bk/C | 8.6 |
| Example 10 | Ink 9 | 12.8 | Comparative | Ink 10 | 9.1 |
| | Ink 12 | 4.2 | Example7 | Ink 14 | 2.0 |
| | Bk/C | 3.0 | | Bk/C | 4.5 |
| Example 11 | Ink 10 | 9.1 | | | |
| | Ink 13 | 3.4 | | | |
| | Bk/C | 2.7 | | | |
| Example 12 | Ink 11 | 7.7 | | | |
| | Ink 14 | 2.0 | | | |
| | Bk/C | 3.9 | | | |

### Experimental Example 1

Test of Cartridge Storage Stability

Ink compositions obtained in Examples 1 trough 6 and Comparative Examples 1 through 3 were filled into ink cartridges manufactured by Samsung, and left alone at an ambient temperature (25° C.) and low temperature (−5° C.) for two weeks. When printing was carried out using the ink cartridges, a degree to which the ink was not discharged due to nozzle clogging was determined according to the following standards. The results are shown in Table 4 below.

⊚: 5% or less of the existing nozzles are clogged

◯: 6˜10% of the existing nozzles are clogged

×: 11-20% of the existing nozzles are clogged

××: 21% or more of the existing nozzles are clogged

### Experimental Example 2

Test of Drying Characteristics

Ink compositions obtained in Examples 1 through 6 and Comparative Examples 1 through 3 were refilled into ink cartridges M-50 manufactured by Samsung, and each ink cartridge was mounted in a printer (MJC-2400C, manufactured by Samsung). A histogram (3×20 cm) was printed using the printer above. Immediately after printing, an unprinted printing paper was stacked on the printed surface, and the stacked printing papers were passed through a press roll tester. An OD value of a transferred image was measured after the stacked printing papers were passed through the press roll tester and the OD value of an original image were determined, compared, and represented as a percentage according to the following equation, and evaluated according to the following standards.
A=(OD of transferred image/OD of original image)×100(%)

⊚: A<15

◯: 15≦A<30

×: 30≦A≦45

××: A>45

### Experimental Example 3

Test of Bleeding Resistance

Ink compositions obtained in Examples 1 through 6 and Comparative Examples 1 through 3 were filled into ink cartridges M-50 manufactured by Samsung, and each ink cartridge was mounted in a printer (MJC-2400C, manufactured by Samsung). Test patterns were printed using the printer and C-60 color ink (manufactured by Samsung). After 30 minutes from the printing, the position of a dot line between two color boundary lines where color mixing had occurred were observed using a microscope (refer to U.S. Pat. No. 5,854,307 for evaluation standards).

The degree of bleeding was evaluated according to the following standards.

5: No color mixing in total boundary

4: color mixing occurred in the width corresponding to 1 dot diameter

3: color mixing occurred in the width corresponding to 2 dot diameter

2 color mixing occurred in the width corresponding to 3 dot diameter

1 color mixing occurred in the width corresponding to 4 dot diameter

(wherein, 1 dot diameter=100 /a based on 600 dpi)

TABLE 4

| | Difference of dynamic | | | | |
|---|---|---|---|---|---|
| | surface tension | | Cartridge | Drying | |
| | (dyne/cm) | | Storage | Char- | Bleeding |
| Example | 10 ms | 1000 ms | Stability | acteristic | Resistance |
| Example 1 | 12.7 | 13.5 | ⊚ | ⊚ | 5 |
| Example 2 | 15.5 | 14.5 | ⊚ | ⊚ | 5 |
| Example 3 | 18.5 | 18.6 | ⊚ | ⊚ | 5 |
| Example 4 | 2.8 | 1.0 | ⊚ | ⊚ | 5 |
| Example 5 | 3.0 | 4.1 | ⊚ | ⊚ | 5 |
| Example 6 | 5.8 | 5.1 | ⊚ | ⊚ | 5 |
| Comparative | 27.2 | 21.4 | X | XX | 2 |
| Example 1 | | | | | |
| Comparative | 28.3 | 22.6 | X | XX | 2 |
| Example 2 | | | | | |
| Comparative | 25.3 | 20.8 | X | XX | 2 |
| Example 3 | | | | | |

As illustrated in FIG. 4, Examples 1-6, in which the dynamic surface tensions of the different inks are within 20 dyne/cm or each other at 10 ms and at 1000 ms, are superior in cartridge storage stability, drying characteristics, and bleeding resistance, as compared to Comparative Examples 1-2, in which the dynamic surface tensions of the inks are not within 20 dyne/cm of each other.

### Experimental Example 4

Test of Bleeding Resistance

Ink compositions obtained in Examples 7 through 12 and Comparative Examples 4 through 7 (See Table 3) were filled into ink cartridges M-50 manufactured by Samsung, and each ink cartridge was mounted in a printer (MJC-2400C, manufactured by Samsung). A histogram (5×5 cm) was printed using the printer. After Color Gamut (La*b*) was determined using a colorimeter (Datacolor SF600 PLUS-CT), the difference between a* and b* was compared among the ink compositions. The results are shown in Table 5 below.
ΔE*_{ab}=|a*−b*|, absolute value of the difference between a* and b*

⊚: ΔE*_{ab}<1

◯: 1≦ΔE*_{ab}<2.15

×:: 2.15≦ΔE*_{ab}≦6

××: ΔE*_{ab}>6

TABLE 5

| | Drop volume | | Drop volume ratio | |
|---|---|---|---|---|
| Example | Bk | Color | Bk/Color | Color Gamut |
| Example 7 | 17.2 | 5.6 | 3.1 | ⊚ |
| Example 8 | 17.2 | 4.8 | 3.6 | ◯ |
| Example 9 | 17.2 | 4.4 | 3.9 | ◯ |
| Example 10 | 12.8 | 4.2 | 3.0 | ⊚ |
| Example 11 | 9.1 | 3.4 | 2.7 | ⊚ |
| Example 12 | 7.7 | 2.0 | 3.9 | ◯ |
| Comparative | 17.2 | 4.2 | 4.1 | X |
| Example 4 | | | | |
| Comparative | 17.2 | 3.4 | 5.1 | X |
| Example 5 | | | | |
| Comparative | 17.2 | 2.0 | 8.6 | XX |
| Example 6 | | | | |
| Comparative | 9.1 | 2.0 | 4.5 | X |
| Example 7 | | | | |

As illustrated in FIG. 4, in Examples 7-12, in which the drop volume of the black ink is no more than four times greater than the drop volume of the respective color ink, the color gamut is superior as compared to Comparative Examples 4-7, in which the drop volume of the black ink is more than four times greater than the drop volume of the respective color ink.

When a full color image is printed on a recording medium using an ink set including inks having similar dynamic surface tensions according to an embodiment of the present general inventive concept, a drying time of the ink is shortened, and a clear image without color boundary bleeding can be realized with reproducibility. In addition, the ink set has excellent discharging stability as well as long term storage stability. Accordingly, the ink set can be used in various applications, for example, in ink jet inks, printing inks, paints, printing, the manufacture of cosmetics, ceramics, and the like.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink set comprising at least two color inks having different colors, each color ink comprising:
colorants;
surfactants;
organic solvents; and
water, wherein a difference between dynamic surface tensions of the at least two inks is 20 dyne/cm or less at 10 ms and 1000 ms.

2. The ink set according to claim 1, wherein the at least two color inks comprise a first color ink and a second color ink, and the difference between the dynamic surface tension of the second color ink and the dynamic surface tension of the first color ink is 20 dyne/cm or less at 10 ms and 1000 ms.

3. The ink set according to claim 1, wherein the at least two color inks comprise a first color ink, a second color ink, and a third color ink, the difference between the dynamic surface tension of the second color ink and the dynamic surface tension of the first color ink is 20 dyne/cm or less at 10 ms and 1000 ms, and the difference between the dynamic surface tension of the third color ink and the dynamic surface tension of the first color ink is 20 dyne/cm or less at 10 ms and 1000 ms.

4. The ink set according to claim 1, wherein, the at least two color inks comprise a first color ink, a second color ink, a third color ink, and a fourth color ink, the difference between the dynamic surface tension of the second color ink and the dynamic surface tension of the first color ink is 20 dyne/cm or less at 10 ms and 1000 ms, the difference between the dynamic surface tension of the third color ink and the dynamic surface tension of the first color ink is 20 dyne/cm or less at 10 ms and 1000 ms, and the difference between the dynamic surface tension of the fourth color ink and the dynamic surface tension of the first color ink is 20 dyne/cm or less at 10 ms and 1000 ms.

5. The ink set according to claim 1, wherein the colorants comprise at least one of self-dispersing dyes, self-dispersing pigments, and dyes or pigments that are used in combination with dispersants.

6. The ink set according to claim 1, wherein the colorants comprise black pigments and color dyes or pigments containing at least one color colorant selected from a group consisting of magenta, cyan, yellow, red, green, and blue.

7. The ink set according to claim 1, wherein the ink set comprises black ink containing black colorants and at least one color ink containing at least one color colorant selected from a group consisting of magenta, cyan, yellow, red, green, and blue, and a drop volume of the black ink is no more than four times greater than a drop volume of the color ink.

8. The ink set according to claim 1, wherein the ink set comprises black ink containing black colorants and at least one color ink containing at least one color colorant selected from a group consisting of magenta, cyan, yellow, red, green, and blue, and a drop volume of the black ink is 18 pl or less.

9. The ink set according to claim 1, wherein the dynamic surface tension of each color of the ink is in a range of substantially 30 to 70 dyne/cm at 10 ms and is in a range of substantially 22 to 60 dyne/cm at 1000 ms.

10. The ink set according to claim 1, wherein the surfactants comprise at least one of:
at least one ionic surfactant selected from a group consisting of salts of alkylcarboxylic acid, salts of alcohol sulfonic acid ester, salts of alkylsulfonic acid, salts of alkylbenzenesulfonic acid, fatty acid amine salts, quaternary ammonium salts, sulfonium salts, and phosphonium salts; and
at least non-ionic surfactants selected from a group consisting of polyoxyethylene alkyl ether, polyoxyethylene alkyl phenyl ether, polyoxyethylene secondary alcohol ether, polyoxyethylene-oxypropylene block copolymer, polyglycerin fatty acid ester, sorbitan monoester alkoxylate, acetylenic polyakylene oxide, and acethylenic diol.

11. The ink set according to claim 1, wherein the organic solvents comprise at least one of:
alcohol compounds including one or more of methyl alcohol, ethyl alcohol, n-propyl alcohol, isopropyl alcohol, n-butyl alcohol, sec-butyl alcohol, t-butyl alcohol, and isobutyl alcohol;
at least one polyhydric alcohol compound selected from a group consisting of 1,6-hexandiol, 1,2-hexandiol, ethylene glycol, diethylene glycol, triethylene glycol, propylene glycol, buthylene glycol, 1,4-butanediol, 1,2,4-butanetriol, 1,5-pentanediol, 1,2,6-hexanetriol, trimethanol propane, hexylene glycol, glycerol, and poly (ethylene glycol);
at least one ketone compound selected from a group consisting of acetone, methyl ethyl ketone, and diacetone alcohol;
one or more esters selected from a group consisting of ethylacetate and ethyl lactate;
at least one lower alkyl ether compound selected from a group consisting of ethylene glycol monomethyl ether, ethylene glycol monoethyl ether, diethylene glycol methyl ether, diethylene glycol ethyl ether, diethylene glycol monobutyl ether, diethylene glycol diethylene ether, triethylene glycol monomethyl ether, triethylene, and glycol monoethyl ether; and
at least one sulfur-containing compound selected from a group consisting of dimethyl sulfoxide, tetramethylenesulfone, and thioglycol.

12. The ink set according to claim 1, wherein the organic solvents comprise at least one amide-based compound selected from a group consisting of 2-pyrrolidone, 2-piperidone, N-methyl-pyrrolidone, caprolactame, tetrahydro-2-pyrimidone, 3-methyl-tetrahydro-2-pyrimidone, 2-imidazolidinone, dimetylimidazolidinone, diethylimidazolidinone, butyl urea, 1,3-dimethyl urea, ethyl urea, propyl urea, isopropyl urea, and 1,3-diethyl urea.

13. The ink set according to claim 1, wherein an amount of the water is in a range of substantially 1 to 30 parts by weight based on 1 part by weight of the colorants.

14. The ink set according to claim 1, wherein a total amount of the organic solvents is in a range of substantially 0.5 to 20 parts by weight based on 1 part by weight of the colorants.

15. The ink set according to claim 1, wherein each of the at least two color inks has a static surface tension of substantially 15-70 dyne/cm and a viscosity of substantially 1-20 cP at 20° C.

16. The ink set according to claim 1, wherein the ink set is usable with an ink jet printer having an array head including 10,000 or more nozzles.

17. The ink set according to claim 16, wherein one of the at least two color inks comprises a black ink, and a drop volume of the black ink is 18 pl or less.

18. An ink jet printer cartridge comprising an ink set including at least two color inks having different colors, each color ink comprising:
colorants;
surfactants;
organic solvents; and
water, wherein a difference between dynamic surface tensions of the at least two inks is 20 dyne/cm or less at 10 ms and 1000 ms.

19. The ink jet printer cartridge according to claim 18, wherein the ink set is usable in an ink jet printer with an array head including 10,000 or more nozzles.

20. The ink jet printer cartridge according to claim 19, wherein one of the at least two color inks comprises a black ink, and a drop volume of the black ink is 18 pl or less.

21. An ink jet printing apparatus comprising:
an ink jet printer cartridge containing an ink set including at least two color inks having different colors, each color ink comprising colorants, surfactants, organic solvents, and water, wherein a difference between dynamic surface tensions of the at least two inks is 20 dyne/cm or less at 10 ms and 1000 ms.

22. An ink jet cartridge set, comprising:
a plurality of ink jet cartridges respectively containing a plurality of different color inks, each color ink having a dynamic surface tension within 20 dyne/cm of the dynamic surface tensions of the other color inks at 10 ms and at 1000 ms during a formation of droplets of the different color inks.

23. An ink jet printing apparatus, comprising:
one or more ink cartridges;
an ink set provided in the one or more ink cartridges, the ink set comprising a plurality of different color inks, each color ink having a dynamic surface tension within 20 dyne/cm of the dynamic surface tensions of the other color inks at 10 ms and at 1000 ms during a formation of bubbles of the different color inks; and
an ink jet print head having a plurality of nozzles to eject the different color inks of the ink set onto a printing medium to form an image on the printing medium.

24. The ink jet printing apparatus according to claim 23, wherein the ink jet print head comprises an array print head having the plurality of nozzles disposed over a width of the printing medium.

25. The ink jet printing apparatus according to claim 23, wherein the ink jet print head comprises 10,000 or more nozzles.

26. The ink jet printing apparatus according to claim 23, wherein one of the plurality of different color inks is black ink, and the ink jet print head ejects the black ink onto the printing medium at a first drop volume and ejects the other color inks at a second drop volume of no more than four times smaller than the first drop volume.

27. The ink jet printing apparatus according to claim 26, wherein the first drop volume is less than or equal to 18 pl.
